(19) United States
(12) Patent Application Publication
(10) Pub. No.: US 2025/0310453 A1
(43) Pub. Date: Oct. 2, 2025

(54) INFORMATION PROCESSING APPARATUS, INFORMATION PROCESSING SYSTEM, INFORMATION PROCESSING METHOD, AND STORAGE MEDIUM

(71) Applicant: Konica Minolta, Inc., Tokyo (JP)

(72) Inventor: Naoto KUBO, Tokyo (JP)

(21) Appl. No.: 19/094,383

(22) Filed: Mar. 28, 2025

(30) Foreign Application Priority Data
Apr. 2, 2024 (JP) 2024-059435

(51) Int. Cl. H04N 1/00; H04N 1/32

(52) U.S. Cl. CPC H04N 1/00806; H04N 1/32101; H04N 2201/0094

(57) ABSTRACT

An information processing apparatus includes: a setting unit that sets pieces of sheet information on sheets; a storage that stores multiple predetermined requirements; and a hardware processor. The hardware processor determines whether characteristic information of a sheet that has a piece of sheet information set by the setting unit satisfies a predetermined requirement corresponding to the sheet among the predetermined requirements stored in the storage.

### CROSS-REFERENCE TO RELATED APPLICATIONS

The entire disclosure of Japanese Patent Application No. 2024-059435 filed on Apr. 2, 2024, is incorporated herein by reference in its entirety.

### BACKGROUND OF THE INVENTION

### Technical Field

The present invention relates to an information processing apparatus, an information processing system, an information processing method, and a storage medium.

### Description of Related Art

In a commercial printing field, printing on wrong sheets requires reprinting. Reprinting causes printing companies or users a great loss in terms of time and cost.

For example, Japanese Unexamined Patent Publication No. 2005-77855 discloses a configuration of detecting a mismatch between a set sheet thickness and a sheet thickness detected by a sensor provided on a sheet feeding path. The configuration of JP2005-77855A encourages the user to confirm the setting when the mismatch in paper thickness is detected. Thus, the user can avoid printing on wrong sheets.

Further, Japanese Unexamined Patent Publication No. 2022-30864 discloses a configuration that determines whether a characteristic detected by a sensor provided on a sheet feeding path matches a specified range. The configuration of JP2022-30864A stops printing when determining that the characteristic does not match the specified range. Thus, the user can avoid printing on wrong sheets.

As in the configurations of JP2005-77855A and JP2022-30864A, determining a mismatch between set characteristics and characteristics detected by a sensor is effective as a safety function for preventing printing accidents. However, determining a mismatch requires a high level of determination accuracy (detection rate and accuracy rate). When the threshold for determining a mismatch is too loose, it may not be possible to determine a mismatch when sheets similar to but different from a correct sheet are used. Accordingly, the mismatch detection rate decreases. When the threshold is strict, the mismatch detection rate increases, but the strict threshold increases the number of cases where the mismatch is erroneously detected, and the job is stopped. Accordingly, the accuracy rate and productivity decrease. In both cases, the trust of users may be lost.

In recent years, various types of media (sheets) have emerged in the commercial printing field to add values to printing products. Some sheets have great variations in characteristic values, whereas other sheets have small variations in characteristic values. It is therefore difficult to ensure a high level of determination accuracy with a fixed threshold.

To deal with the above problem, there is known a method to set the level of a threshold (strict, normal, and loose). However, the criterion for setting the level is unclear, and the setting should be changed for each type of sheet. Such procedures are troublesome for the user.

An object of the present invention is to provide an information processing apparatus, an information processing system, an information processing method, and a storage medium that can accurately detect a wrong sheet in printing and that can ensure the reliability and productivity of a user.

### SUMMARY OF THE INVENTION

To achieve at least one of the abovementioned objects, according to an aspect of the present invention, there is provided an information processing apparatus including: a setting unit that sets pieces of sheet information on sheets; a storage that stores multiple predetermined requirements; and a hardware processor that determines whether characteristic information of a sheet that has a piece of sheet information set by the setting unit satisfies a predetermined requirement corresponding to the sheet among the predetermined requirements stored in the storage.

According to an aspect of the present invention, there is provided an information processing system including: a setting unit that sets pieces of sheet information on sheets; a storage that stores multiple predetermined requirements; and a hardware processor that determines whether characteristic information of a sheet that has a piece of sheet information set by the setting unit satisfies a predetermined requirement corresponding to the sheet among the predetermined requirements stored in the storage.

According to an aspect of the present invention, there is provided an information processing method to be performed by an information processing apparatus that includes: a setting unit that sets pieces of sheet information on sheets; and a storage that stores multiple predetermined requirements, the method including: determining whether characteristic information of a sheet that has a piece of sheet information set by the setting unit satisfies a predetermined requirement corresponding to the sheet among the predetermined requirements stored in the storage.

According to an aspect of the present invention, there is provided a non-transitory computer-readable storage medium storing a program to be executed by a computer of an information processing apparatus that includes: a setting unit that sets pieces of sheet information on sheets; and a storage that stores multiple predetermined requirements, wherein the program causes the computer to determine whether characteristic information of a sheet that has a piece of sheet information set by the setting unit satisfies a predetermined requirement corresponding to the sheet among the predetermined requirements stored in the storage.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 illustrates a schematic configuration of an image forming apparatus according to the present embodiment;

FIG. 2 is a functional block diagram illustrating a control structure of the image forming apparatus according to the present embodiment;

FIG. 3 is a flowchart as an example of control by the image forming apparatus according to the present embodiment;

FIG. 4 is a flowchart as an example of data collection process;

FIG. 5 is an example of a characteristic group A, wherein pieces of characteristic information of a sheet A detected by a media sensor are listed;

FIG. 6 is a flowchart as an example of a threshold determination process;

FIG. 7 is a flowchart as an example of an error detection process; and

FIG. 8 is a functional block diagram illustrating a control structure of an information processing system according to a modification example.

### DETAILED DESCRIPTION

Hereinafter, embodiments of the present invention will be described in detail with reference to the drawings. However, the scope of the invention is not limited to the disclosed embodiments.

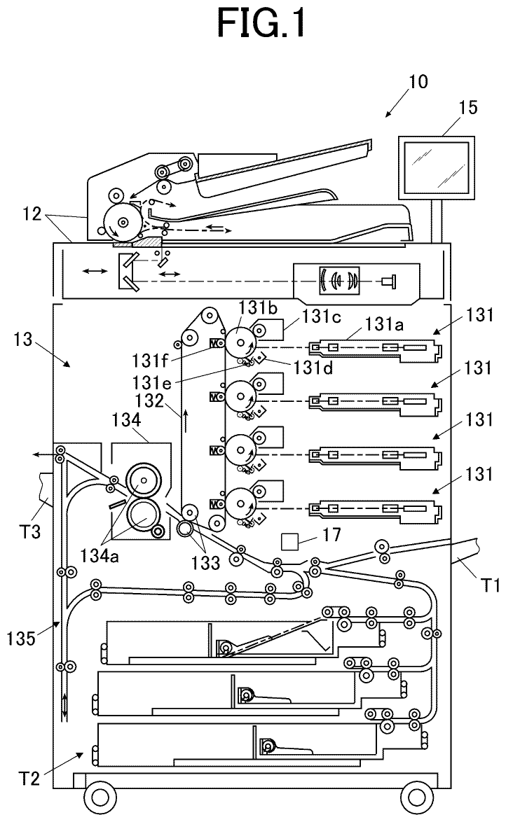

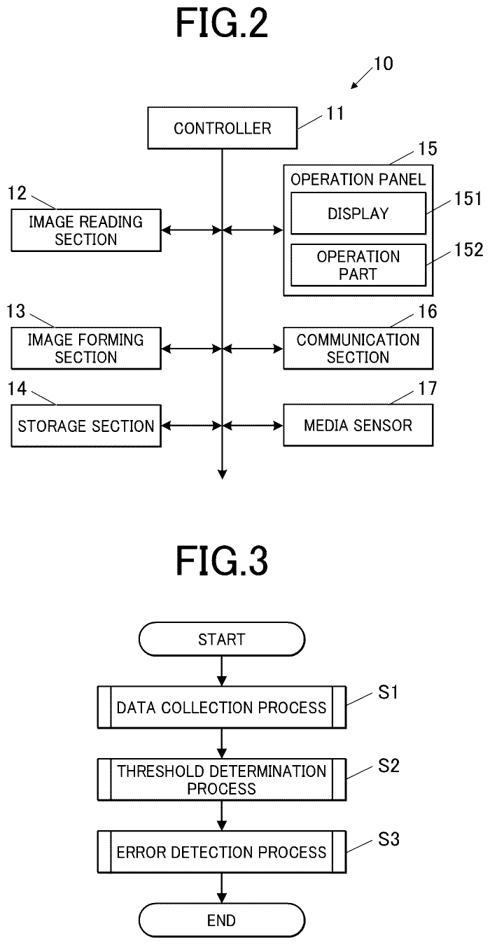

As illustrated in FIG. 1 and FIG. 2, an image forming apparatus 10 according to the present embodiment includes a controller 11, an image reading section 12, an image forming section 13, a storage section 14, an operation panel 15, and a communication section 16, and a media sensor 17.

The controller 11 includes a CPU, a RAM, and a ROM. The CPU reads various processing programs stored in the ROM and loads them in the RAM in response to an instruction signal. The instruction signal is an operation signal input via the operation part 15 or is received by the communication section 16. Then, the CPU centrally controls operations of sections constituting the image forming apparatus 10 in cooperation with various programs loaded in the RAM.

For example, the controller 11 determines whether characteristic information of a sheet for which sheet information has been set via the operation part 152 satisfies a predetermined requirement. The controller 11 thus functions as a determination unit of the present invention.

The image reading section 12 reads an image of a document placed on a document table or an automatic document feeder (ADF) (not illustrated) and obtains image signals. Specifically, the image reading section 12 scans and exposes the image of the document by an optical system of a scanning exposure device, reads reflected light by a line image sensor, and obtains the image signals. The image signals are subjected to processing, such as A/D conversion, shading correction, and compression, and are input as image data to the controller 11. The image data input to the controller 11 is not limited to the image data obtained by reading of the image reading section 12. For example, the image data may be received from an external device (not illustrated) via the communication section 16.

The image forming section 13 forms an image composed of four colors of C, M, Y, and K on a sheet, based on four-color pixel values of pixels constituting the processed original image.

The image forming section 13 includes four image forming units 131, an intermediate transfer belt 132, secondary transfer rollers 133, and a fixing section 134.

The four image forming units 131 are arranged in series (tandem) along the belt surface of the intermediate transfer belt 132 and form images of C, M, Y and K colors. The image forming units 131 have the same configuration except that they form images in different colors. Each of the image forming units 131 includes an optical scanner 131a, a photoreceptor 131b, a developing section 131c, a charging section 131d, a cleaning section 131e, and a primary transfer roller 131.

In forming an image, each image forming unit 131 firstly charges the photoreceptor 131b with the charging section 131d. Next, the image forming unit 131 performs scanning on the surface of the photoreceptor 131a with a light flux emitted by the optical scanner 131b, based on the original image. The image forming unit 131 thus forms an electrostatic latent image. Next, the image forming unit 131 causes the developing section 131c to supply color materials, such as toner, to develop the image. Thus, a toner image is formed on the photoreceptor 131b.

The images formed on the respective photoreceptors 131b by the respective image forming units 131 are sequentially transferred and superimposed onto the intermediate transfer belt 132 by the primary transfer rollers 131f. Thus, an image of the colors is formed on the intermediate transfer belt 132. The intermediate transfer belt 132 is an image bearing member that rotates by being wound around rollers. After the primary transfer, each of the image forming units 131 causes the cleaning section 131e to remove the color material remaining on the photoreceptor 131b.

A sheet is fed to the image forming section 13 at the timing when the image on the rotating intermediate transfer belt 132 reaches the secondary transfer rollers 133. The sheet is fed to the image forming section 13 from a manual sheet feed tray T1 or a sheet feed tray T2. The secondary transfer rollers 133 consist of a pair of rollers. One of the secondary transfer rollers 133 is pressed against the intermediate transfer belt 132. The other roller of the secondary transfer rollers 133 is one of rollers that wind the intermediate transfer belt 132. By the press of the secondary transfer rollers 133, the image on the intermediate transfer belt 132 is transferred to the sheet fed to the image forming section 13 (secondary transfer). The sheet after the secondary transfer is conveyed to the fixing section 134 and receives fixing processing. The sheet is then ejected to the sheet ejection tray T3. In the fixing processing, the sheet is heated and pressurized by the fixing roller 134a to fix the image onto the sheet. In forming images on both sides of the sheet, the sheet is conveyed to a reversing path 135 and reversed and again sent to the secondary transfer rollers 133.

The storage section 14 is a non-volatile storage including an HDD, an SSD, or the like. The storage section 14 stores various programs, various kinds of setting data, and so forth to be readable and writable by the controller 11.

The storage section 14 stores multiple predetermined requirements. The predetermined requirements are set for sheet information (paper type and brand) of each type of sheet. The predetermined requirements include a threshold determined for sheet information of each type of sheet and a fixed threshold used in a conventional method.

The operation panel 15 includes a display 151 that displays various kinds of information for the user and an operation part 152 that receives operations input by the user.

The display 151 is a color liquid crystal display, for example. The display 151 displays an operation screen and the like in accordance with display control signals input by the controller 11. The operation screen includes, for example, various setting screens, various buttons, and the operation status of each function.

The operation part 152 includes a touch screen laid on the screen of the display 151 and various hard keys arranged near the screen of the display 151. When a button displayed on the display is pressed with a finger or a touch pen, the operation part 152 detects the X-Y coordinate of the pressed force point by a voltage value. The operation part 152 then outputs an operation signal associated with the detected position to the controller 11. The touch screen is not limited to a pressure-sensitive type, but may be, for example, an electrostatic type or an optical type. When a hard key is pressed, the operation part 152 outputs an operation signal associated with the pressed key to the controller 11. The user can manipulate the operation part 152 to do settings on image formation, to send instructions to convey a sheet, and to stop the apparatus. The settings on image formation include, for example, settings on image quality, magnification, application, outputting sheets, and sheet type.

The operation part 152 also receives setting on sheet information of sheets. The sheet information is, for example, the paper type or the brand of the sheet. That is, the operation part 152 functions as a setting unit of the present invention.

The communication section 16 includes a communication IC and a communication connector. The communication section 16 is an interface that connects the image forming apparatus 10 to a communication network. Under the control of the controller 11, the communication section 16 transmits and receives various kinds of information to and from an external device connected to the communication network according to a predetermined communication protocol. The communication section 16 can also perform input and output of various kinds of information via the USB.

The media sensor 17 is provided on the conveyance path on which the sheet is conveyed to the image forming section 13. The media sensor 17 reads a sheet fed from the manual sheet feed tray Tl or the sheet feed tray T2 and detects characteristic information of the sheet. The characteristic information includes information on characteristics of the sheet, such as paper thickness, basis weight, and surface property (smoothness, moisture percentage), for example. The characteristic information may include at least one of information on the paper thickness, information on the basis weight, and information on the surface property. The detected characteristic information is output to the controller 11. That is, the media sensor 17 functions as a detection unit of the present invention that detects the characteristic information of the sheet for which the sheet information has been set by the operation part 152.

The information processing apparatus of the present invention includes at least the setting unit (operation part 152), a determination unit (controller 11), and the storage section 14.

Next, the control by the image forming apparatus 10 according to the present embodiment will be described with reference to the flowchart of FIG. 3. FIG. 3 shows an example of the control to determine an optimum threshold for the sheet A and perform error detection. The sheet A is a sheet for which sheet information (paper type and brand) has been set by the operation part 152.

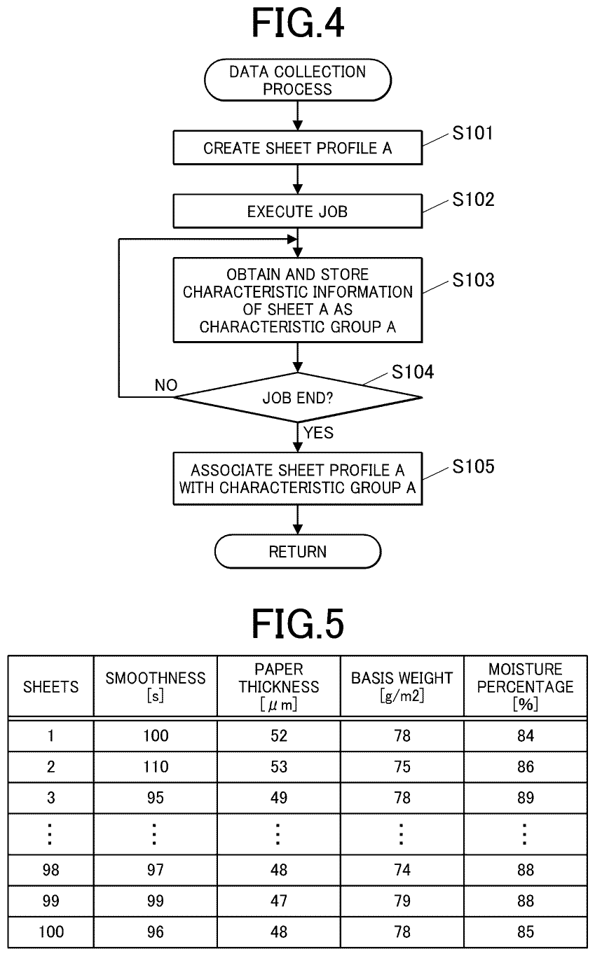

First, the controller 11 performs a data collecting process (step S1). The data collection process is to collect data necessary for determining a threshold for the sheet A. The data collection process will be described with reference to the flowchart of FIG. 4.

First, the controller 11 creates a sheet profile A that is a collection of image forming requirements (printing conditions) on the sheet A (medium A) (step S101). The sheet profile A created in step S101 is stored in the storage section 14.

Next, the controller 11 executes a print job on the sheet A (step S102). Specifically, the controller 11 reads the sheet profile A of the sheet A from the storage section 14 and executes the job in accordance with the sheet profile A.

Next, the controller 11 obtains the characteristic information of the sheet A detected by the media sensor 17, lists the characteristic information, and stores the list in the storage section 14 (step S103).

FIG. 5 illustrates an example of the characteristic group A as a list of pieces of characteristic information on the sheet A obtained in step S103. The characteristic group A is a list of pieces of characteristic information on the sheet A obtained when a job of 100 pages was executed on the sheet A. In FIG. 5, smoothness, paper thickness, basis weight, and moisture percentage are shown as examples of the characteristic information.

Next, the controller 11 determines whether the job is completed (step S104).

When determining that the job is completed (step S104: YES), the controller 11 proceeds to the next step S105.

When determining that the job is not completed (step S104: NO), the controller 11 proceeds to step S103.

In step S105, the controller 11 associates the sheet profile A with the characteristic group A.

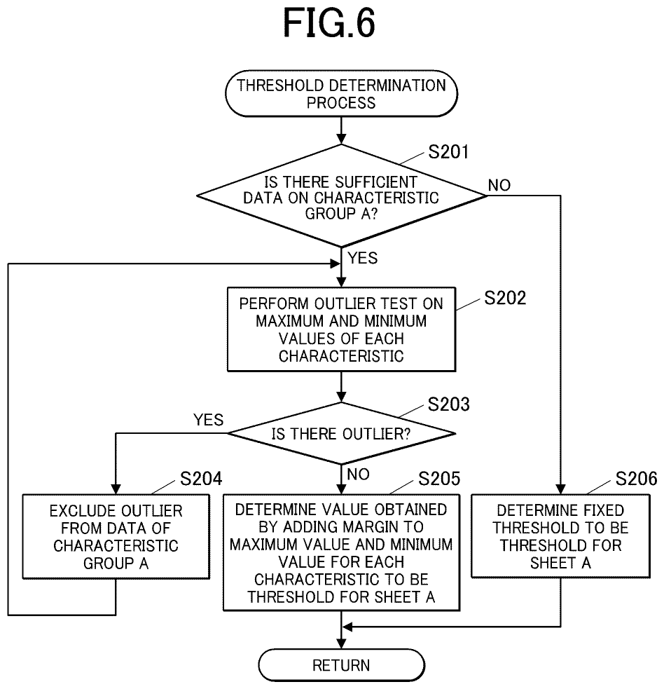

Returning to FIG. 3, the controller 11 performs a threshold determination process (step S2). The threshold determination process is to determine a threshold for the sheet A. Hereinafter, the threshold determination process will be described with reference to the flowchart of FIG. 6.

First, the controller 11 determines whether a sufficient amount of the characteristic group A is stored in association with the sheet profile A (step S201). The sufficient amount of the characteristic group A corresponds to, for example, 100 pages.

When determining that the sufficient amount of characteristic group A is stored (step S201: YES), the controller 11 proceeds to the next step S202.

On the other hand, when determining that the sufficient amount of characteristic group A is not stored (step S201: NO), the controller 11 proceeds to step S206.

In step S202, the controller 11 performs an outlier test on the maximum and minimum values of each characteristic in the characteristic group A. Specifically, first, the controller 11 reads the characteristic group A from the storage section 14 and extracts the maximum value and the minimum value of each characteristic (smoothness, paper thickness, basis weight, and moisture percentage). Next, the controller 11 performs the outlier test on the maximum value and the minimum value of each characteristic. The outlier test is, for example, the Smirnov-Grubbs test. The outlier test is performed at a significant level of 5%.

Next, the controller 11 determines, based on the result of the outlier test, whether there is an outlier (step S203).

When determining that there is an outlier (step S203: YES), the controller 11 proceeds to the next step S204.

On the other hand, when determining that there is no outlier (step S203: NO), the controller 11 proceeds to step S205.

In step S204, the controller 11 excludes the outlier from the characteristic group A. Thereafter, the controller 11 proceeds to step S202.

In step S205, the controller 11 adds a fixed margin to the maximum value and the minimum value of each characteristic in the characteristic group A from which outliers have been excluded. The controller 11 determines the values to which the fixed margin is added to be a threshold for the sheet A. Thus, the threshold is determined for each piece of sheet information of the sheet (e.g., paper type and brand of sheet A). The threshold determined in step S205 is stored in the storage section 14.

As described above, based on the sheet information and the sheet profile, the controller 11 sets (determines) the requirements for each piece of sheet information. That is, the controller 11 functions as a requirement setting unit of the present invention.

In step S206, the controller 11 determines a fixed threshold that is used in a conventional method as the threshold for the sheet A. The fixed threshold is stored in the storage section 14 in advance.

If a sufficient amount of the characteristic group A is not stored (step S201: NO), a threshold is not set for the sheet A. In such a case, the fixed threshold is used to perform error detection.

In the present embodiment, when a threshold for the sheet A is not set, the controller 11 determines whether the characteristic information of the sheet A detected by the media sensor 17 satisfies a common predetermined requirement (fixed threshold) that does not depend on the sheet A.

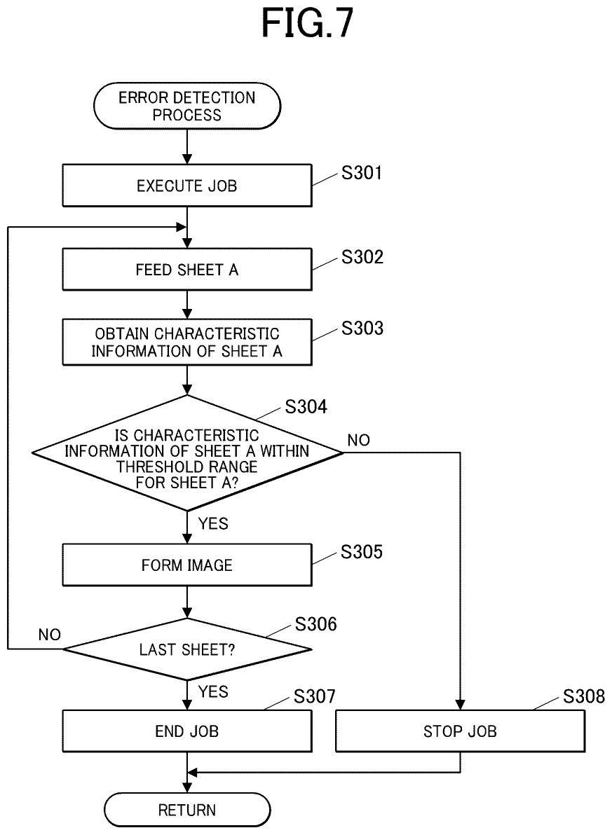

Referring back to FIG. 3, the controller 11 performs an error detection process (step S3). The error detection process is to detect a sheet error (a state where a sheet having different sheet information is inserted). The error detection process is performed when the error detection function is activated by the setting. Hereinafter, the error detection process will be described with reference to the flowchart of FIG. 7.

First, the controller 11 executes a print job on the sheet A (step S301). Specifically, the controller 11 reads the sheet profile A of the sheet A from the storage section 14 and executes the job in accordance with the sheet profile A.

Next, the controller 11 feeds the sheet A from the manual sheet feed tray T1 or the sheet feed tray T2 (step S302).

Next, the controller 11 obtains characteristic information of the sheet A detected by the media sensor 17 (step S303).

Next, the controller 11 determines whether the characteristic information of the sheet A obtained in step S303 falls within a threshold range for the sheet A (step S304). The threshold for the sheet A is determined in step S205 or step S206 of FIG. 6.

When determining that the characteristic information of the sheet A falls within the threshold range for the sheet A (step S304: YES), the controller 11 determines that the correct sheet is used and proceeds to the next step S305.

On the other hand, when determining that the characteristic information of the sheet A does not fall within the threshold range for the paper A (step S304: NO), the controller 11 determines that a wrong sheet is used and proceeds to step S308.

That is, the controller 11 determines whether the characteristic information of the sheet A satisfies a predetermined requirement for the sheet A among multiple predetermined requirements (thresholds) stored in the storage section 14.

In step S305, the controller 11 controls the image forming section 13 to form an image on the sheet A the characteristic information of which has been detected by the media sensor 17.

Next, the controller 11 determines whether the fed sheet is the last sheet (step S306).

When determining that the fed sheet is the last sheet (step S306: YES), the controller 11 ends the job (step S307). Thereafter, the control in FIG. 3 ends.

On the other hand, when determining that the fed sheet is not the last sheet (step S306: NO), the controller 11 proceeds to step S302.

In step S308, the controller 11 stops the job. Thereafter, the control in FIG. 3 ends.

As described above, the information processing apparatus according to the present embodiment includes the setting unit (the operation part 152), the determination unit (the controller 11), and the storage section 14. The setting unit sets sheet information of a sheet. The determination unit determines whether the characteristic information of the sheet for which the sheet information has been set by the setting unit meets a predetermined requirement. The storage section 14 stores multiple predetermined requirements. The determination unit determines whether the characteristic information of the sheet for which the sheet information has been set by the setting unit satisfies a predetermined requirement among multiple predetermined requirements stored in the storage section 14. The predetermined requirement corresponds to the sheet for which the sheet information has been set by the setting unit.

Therefore, the information processing apparatus of the present embodiment can detect a wrong sheet, based on appropriate thresholds that have been set beforehand corresponding to the characteristics of the paper. Thus, a wrong sheet can be accurately detected in printing to secure reliability and productivity of the user.

The predetermined requirement is set for each piece of sheet information. The image forming apparatus includes the requirement setting unit (controller 11) that sets a requirement for each piece of sheet information, based on the sheet information and the sheet profile (image forming conditions) of the sheet for which the sheet information has been set by the setting unit. The sheet information is a paper type or a paper brand.

Thus, an appropriate threshold can be automatically set according to characteristic variations of each sheet information. Thus, a wrong sheet can be accurately detected in printing to secure reliability and productivity of the user.

The information processing apparatus also includes the detection unit (media sensor 17) that detects the characteristic information of the sheet for which the sheet information has been set by the setting unit. The determination unit determines whether the characteristic information detected by the detection unit satisfies a predetermined requirement corresponding to the sheet for which the sheet information has been set by the setting unit. The characteristic information includes at least one of information on paper thickness, information on basis weight, and information on surface property.

Thus, it is possible to detect a wrong sheet by using the characteristic information detected by the detection unit. Thus, a wrong sheet can be accurately detected in printing to secure reliability and productivity of the user.

Further, in a case where the predetermined requirement is not set for the sheet for which the sheet information has been set by the setting unit, the determination unit determines whether the characteristic information detected by the detection unit meets a common predetermined requirement that does not depend on the sheet for which the sheet information has been set by the setting unit.

Therefore, even when the amount of data is insufficient, a fixed threshold can be used to detect a wrong sheet.

Thus, a wrong sheet can be certainly detected.

The detection unit is provided in the conveyance path on which the sheet is conveyed.

Therefore, a wrong sheet can be detected by using the characteristic information detected in-line. Thus, a wrong sheet can be detected in real time during printing.

Although the present invention has been described in detail based on the embodiment, the present invention is not limited to the above-described embodiment. The embodiment can be modified without departing from the spirit and scope of the invention.

For example, although the characteristic information on the sheet is collected in executing the job in the embodiment described above, the present invention is not limited thereto. The operation mode for collecting data may be further provided so that data collection is performed separately from job execution, for example. Further, data collection may be performed at the time of adjustment involving sheet conveyance, such as front/back adjustment. For another example, an external media sensor that is not installed on the conveyance path of the image forming apparatus 10 may collect data.

Further, although the Smirnov-Grubbs test is used as an example of the outlier test in the above embodiment, the outlier test is not limited thereto. The outlier test may be performed by a method other than the Smirnov-Grubbs test.

Further, the significance level in the outlier test and the fixed margin that is added in determining the threshold may be changed as desired via the operation part 152.

Further, in the above-described embodiment, the characteristic information on the sheet is collected in the data collection process. The present invention is not limited thereto, though. For example, when it is determined in the error detection process that characteristic information of the sheet falls within a threshold range, the characteristic information may be added to the characteristic group of the sheet.

Further, the current characteristic group may be deleted at the time a job ends, and characteristic information collected in the job may be listed as a new characteristic group. Further, the current characteristic group and the characteristic group collected in a job may be compared at the timing the job ends. When a statistically significant difference is observed, the entire current characteristic group may be replaced by the characteristic group collected in the job. When a statistically significant difference is not observed, the characteristic group collected in the job may be added to the current characteristic group.

When it is determined in the error detection process that a wrong sheet is used (the characteristic information of the sheet does not fall within the threshold range), the display 151 may display a screen for the user to check the sheet. In this case, the image processing apparatus is configured such that the user can input a determination result as to whether the wrong sheet is really used.

For example, when the user inputs “this is not a wrong sheet”, it can be seen that the current characteristic group does not contribute to correctly detecting a wrong sheet. Therefore, the current characteristic group is deleted.

Further, when the user inputs “this is not a wrong sheet”, it is possible that the value of the characteristic information of the sheet is within an allowable range for the user even if the value of the characteristic information corresponds to the usage of a wrong sheet. In such a case, the threshold is extended to a range including the value of the characteristic information of the sheet determined as a wrong sheet in the error detection process.

In Step S206 of FIG. 6, in a case where the fixed threshold is determined as the threshold for the sheet A, it can be seen that the data on the characteristic group A is insufficient. In such a case, a data collection flag may be turned on, and the data on the characteristic group A may be collected.

Although the image forming apparatus 10 as a single apparatus implements the present invention in the above embodiment, the present invention is not limited thereto. For example, the present invention may be implemented by an image processing system 1 that includes the image forming apparatus 10 and a PC 20.

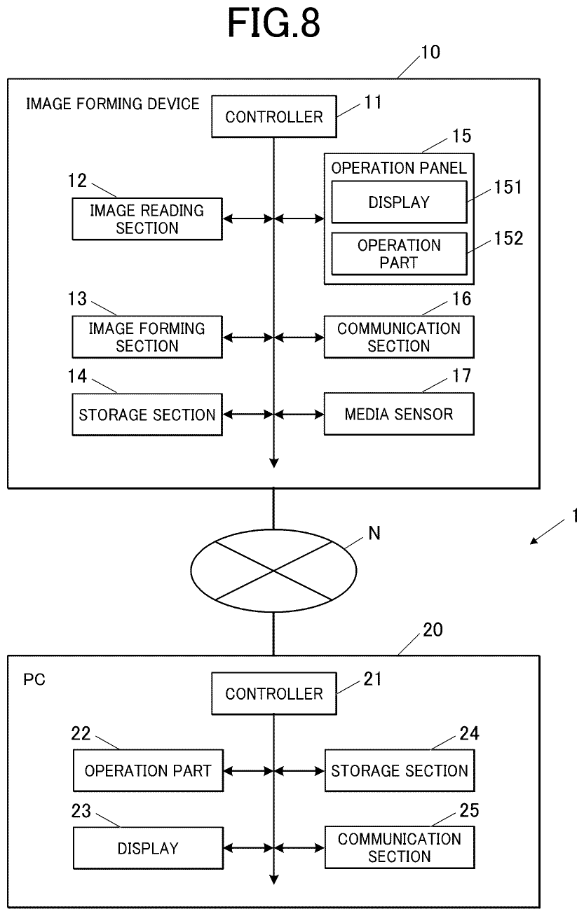

As illustrated in FIG. 8, the information processing system 1 includes the image forming apparatus 10 and the PC 20. The apparatuses constituting the information processing system 1 are connected to the communication network N. The communication network N is, for example, the Internet, a telephone line network of a telecommunications carrier, or a mobile phone communication network. Since the image forming apparatus 10 has the same configuration as that of the embodiment, the description thereof is omitted.

The PC 20 is a terminal device, such as a desktop PC or a notebook PC to be used by the user who have introduced the information processing system 1. As illustrated in FIG. 8, the PC 20 includes a controller 21, an operation part 22, a display 23, a storage section 24, and a communication section 25.

The controller 21 includes a CPU, a ROM, and a RAM. The controller 21 centrally controls operations of the components constituting the PC 20 in accordance with the program loaded in the work area of the RAM. The program data is stored in the ROM or the storage section 24.

The operation part 22 includes, for example, a keyboard having character input keys and number input keys and a pointing device such as a mouse. The operation part 22 receives an operation input by the user and outputs an operation signal corresponding to the operation input to the controller 21.

The display 23 includes, for example, a display such as an LCD. The display 23 displays an image based on a display control signal output by the controller 21 on a display screen. The storage section 24 is constituted by, for example, an HDD and a semiconductor memory. The storage section 24 stores data such as program data and various types of setting data in a manner readable and writable by the third controller 21.

The communication section 25 includes a communication IC and a communication connector. The communication section 25 is a communication interface. The communication section 25 performs data communication via the communication network N using a predetermined communication protocol under the control of the controller 21.

In the information process system 1, the controller 21 of the PC 20 functions as a determination unit and a requirement setting unit of the present invention. The storage section 24 of the PC 20 functions as a storage section of the present invention. The operation part 22 of the PC 20 functions as a setting unit of the present invention.

Part of the functions of the determining unit, the storage section, and the setting unit of the present invention may be done by the image forming apparatus 10, and the remaining functions may be done by the PC 20.

The detailed configuration and the detailed operation of each device constituting the information processing system can be appropriately changed without departing from the scope of the present invention.

Although embodiments of the present invention have been described and shown in detail, the disclosed embodiments are made for purposes of illustration and example only and not limitation. The scope of the present invention should be interpreted by terms of the appended claims.

1. An information processing apparatus comprising:
a setting unit that sets pieces of sheet information on sheets;
a storage that stores multiple predetermined requirements; and
a hardware processor that determines whether characteristic information of a sheet that has a piece of sheet information set by the setting unit satisfies a predetermined requirement corresponding to the sheet among the predetermined requirements stored in the storage.

2. The information processing apparatus according to claim 1, wherein the predetermined requirements are set for the respective pieces of sheet information.

3. The information processing apparatus according to claim 2, wherein, based on the pieces of sheet information and sheet profiles of the sheets having the pieces of sheet information set by the setting unit, the sheet profiles being image forming conditions of the sheets, the hardware processor sets the predetermined requirements for the respective pieces of sheet information.

4. The information processing apparatus according to claim 1, further comprising a detection unit that detects the characteristic information of the sheet,
wherein the hardware processor determines whether the characteristic information of the sheet detected by the detection unit satisfies the predetermined requirement corresponding to the sheet.

5. The information processing apparatus according to claim 1, wherein the sheet information includes a paper type or a paper brand.

6. The information processing apparatus according to claim 4, wherein, in a case where the predetermined requirement for the sheet is not set, the hardware processor determines whether the characteristic information of the sheet detected by the detection unit satisfies a common predetermined requirement that does not depend on the sheet.

7. The information processing apparatus according to claim 4, wherein the detection unit is provided in a conveyance path on which the sheet is conveyed.

8. The information processing apparatus according to claim 1, wherein the characteristic information includes at least one piece of information on a paper thickness, information on a basis weight, and information on a surface property.

9. An image forming apparatus comprising:
an image forming section that forms an image on sheets; and
the information processing apparatus according to claim 4,
wherein in a case where the characteristic information of the sheet detected by the detection unit satisfies the predetermined requirement corresponding to the sheet, the image forming section forms an image on the sheet.

10. An information processing system comprising:
a setting unit that sets pieces of sheet information on sheets;
a storage that stores multiple predetermined requirements; and
a hardware processor that determines whether characteristic information of a sheet that has a piece of sheet information set by the setting unit satisfies a predetermined requirement corresponding to the sheet among the predetermined requirements stored in the storage.

11. An information processing method to be performed by an information processing apparatus that includes:
a setting unit that sets pieces of sheet information on sheets; and a storage that stores multiple predetermined requirements, the method comprising:
determining whether characteristic information of a sheet that has a piece of sheet information set by the setting unit satisfies a predetermined requirement corresponding to the sheet among the predetermined requirements stored in the storage.

12. A non-transitory computer-readable storage medium storing a program to be executed by a computer of an information processing apparatus that includes: a setting unit that sets pieces of sheet information on sheets; and a storage that stores multiple predetermined requirements, wherein the program causes the computer to determine whether characteristic information of a sheet that has a piece of sheet information set by the setting unit satisfies a predetermined requirement corresponding to the sheet among the predetermined requirements stored in the storage.
